(19) United States
(12) Patent Application Publication
(10) Pub. No.: US 2018/0284327 A1
(43) Pub. Date: Oct. 4, 2018

(54) ANTI-GLARE WEAR-RESISTANT COVER PLATE AND MANUFACTURING METHOD THEREOF

(71) Applicant: HENGHAO TECHNOLOGY CO., LTD., Hsin-chu County (TW)

(72) Inventors: Chun-Jung Chen, Taoyuan City (TW); Yu-Tung Chen, Taoyuan City (TW); Chin-Chang Liu, Taichung City (TW)

(73) Assignee: HENGHAO TECHNOLOGY CO., LTD, Hsin-chu County (TW)

(21) Appl. No.: 15/936,476

(22) Filed: Mar. 27, 2018

Related U.S. Application Data
(60) Provisional application No. 62/479,343, filed on Mar. 31, 2017.

(30) Foreign Application Priority Data
Jan. 24, 2018 (TW) 107102450

(51) Int. Cl. G02B 5/02; G02B 1/18

(52) U.S. Cl. CPC G02B 5/0215; G02B 5/0268; G02B 1/18

(57) ABSTRACT

An anti-glare wear-resistant cover plate including a cover plate body is provided. The cover plate body has a plurality of microstructures located at an anti-glare side of the cover plate body. The plurality of microstructures has a plurality of top surfaces, wherein a change in slope of a section line of each of the plurality of top surfaces on a reference plane perpendicular to the cover plate body is continuous. A manufacturing method of the anti-glare wear-resistant cover plate is also provided.

### CROSS-REFERENCE TO RELATED APPLICATION

This application claims the priority benefits of U.S. provisional application Ser. No. 62/479,343, filed on Mar. 31, 2017, and Taiwan application serial no. 107102450, filed on Jan. 24, 2018. The entirety of each of the above-mentioned patent applications is hereby incorporated by reference herein and made a part of this specification.

### BACKGROUND OF THE INVENTION

### Field of the Invention

The invention relates to a cover plate and a manufacturing method thereof, and more particularly, to an anti-glare wear-resistant cover plate and a manufacturing method thereof.

### Description of Related Art

In response to the function of anti-glare in a product, an anti-glare functional layer is often disposed on a surface of an electrical device. Moreover, if an anti-smudge effect is also desired, an anti-smudge functional layer can be disposed on the anti-glare functional layer. However, the surface of the electric device is readily worn from contact, such that the anti-smudge function is lost, and the anti-glare function may even be affected.

### SUMMARY OF THE INVENTION

The invention provides an anti-glare wear-resistant cover plate having good anti-wear capability.

The invention provides a manufacturing method of an anti-glare wear-resistant cover plate that can effectively increase the wear resistance capability of the anti-glare cover plate.

An anti-glare wear-resistant cover plate of the invention includes a cover plate body. The cover plate body has a plurality of microstructures located at an anti-glare side of the cover plate body. The plurality of microstructures has a plurality of top surfaces, wherein a change in slope of a section line of each of the plurality of top surfaces on a reference plane perpendicular to the cover plate body is continuous.

In an embodiment of the invention, a change in slope of a section line of each of the plurality of microstructures on the reference plane is continuous.

In an embodiment of the invention, a depth of each of the plurality of microstructures is between 0 microns and 5 microns, and the distance between any two adjacent microstructures in the plurality of microstructures is greater than or equal to 1 micron and less than 100 microns.

In an embodiment of the present invention, the cover plate body is a glass cover plate.

In an embodiment of the invention, the anti-glare wear-resistant cover plate further includes an anti-smudge layer or an anti-fingerprint layer disposed on the plurality of microstructures.

The manufacturing method of an anti-glare wear-resistant cover plate of the invention includes the following steps. An anti-glare cover plate is provided, wherein the glass transition temperature of the anti-glare cover plate is T. A physical surface heat treatment is performed on an anti-glare side of the anti-glare cover plate at a temperature greater than or equal to T/2 and less than T.

In an embodiment of the invention, the physical surface heat treatment includes laser annealing or flash lamp annealing (FLA).

In an embodiment of the invention, the anti-glare cover plate has a plurality of microstructures. After the physical surface heat treatment is performed, the plurality of microstructures are passivated.

In an embodiment of the invention, after the physical surface heat treatment is performed on the anti-glare side of the anti-glare cover plate, the anti-glare cover plate forms a cover plate body, the cover plate body has a plurality of microstructures corresponding to the plurality of microstructures of the anti-glare cover plate, and a change in slope of a section line of each of the plurality of microstructures of the cover plate body on a reference plane perpendicular to the cover plate body is continuous at least on a top surface of each of the plurality of microstructures. The manufacturing method of the anti-glare wear-resistant cover plate further includes forming an anti-smudge layer or an anti-fingerprint layer on the plurality of microstructures of the cover plate body.

Based on the above, since performing a physical surface heat treatment on the anti-glare side of the anti-glare cover plate facilitates the increase in the hardness of the anti-glare cover plate and can change the surface topography of the anti-glare cover plate such that the anti-glare cover plate is more wear-resistant, the manufacturing method of the anti-glare wear-resistant cover plate of the invention can effectively increase the wear resistance capability of the anti-glare cover plate. Moreover, the anti-glare wear-resistant cover plate made by the manufacturing method above can have good wear resistance capability.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are partial cross sections of a manufacturing process of a manufacturing method of an anti-glare wear-resistant cover plate of the invention.

FIG. 2 shows the relationship between time and light intensity of a physical surface heat treatment.

FIG. 3 is a top view showing a method of performing a physical surface heat treatment at an anti-glare side of an anti-glare cover plate in a dynamic manner.

FIG. 4A is an enlarged view of a region A in FIG. 1A.

FIG. 4B is an enlarged view of a region B in FIG. 1B.

FIG. 5 is a partial cross section of an anti-glare wear-resistant cover plate of the invention.

### DESCRIPTION OF THE EMBODIMENTS

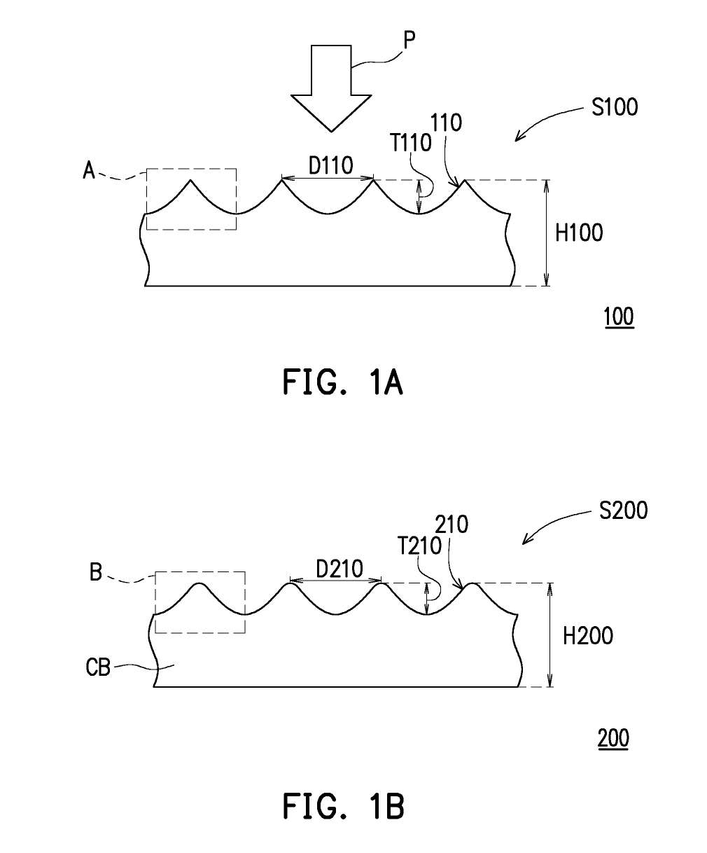

FIG. 1A and FIG. 1B are partial cross sections of a manufacturing process of a manufacturing method of an anti-glare wear-resistant cover plate of the invention. Referring to FIG. 1A, an anti-glare cover plate 100 is provided. The anti-glare cover plate 100 has a plurality of microstructures 110 located at an anti-glare side S100 of the anti-glare cover plate 100. The plurality of microstructures 110 are suitable for scattering the light beam irradiated on the anti-glare side S100 of the anti-glare cover plate 100 to achieve an anti-glare effect. In the embodiment, the anti-glare cover plate 100 is a glass cover plate, and the glass transition temperature of the anti-glare cover plate 100 is T. The plurality of microstructures 110 is, for instance, formed by chemically etching the glass cover plate. In comparison to forming the anti-glare cover plate via a method of surface bonding or vacuum coating, the anti-glare cover plate 100 formed by an etching method can have a relatively thin thickness. In the embodiment, a maximum thickness H100 of the anti-glare cover plate 100 can be less than 1 mm, but is not limited thereto.

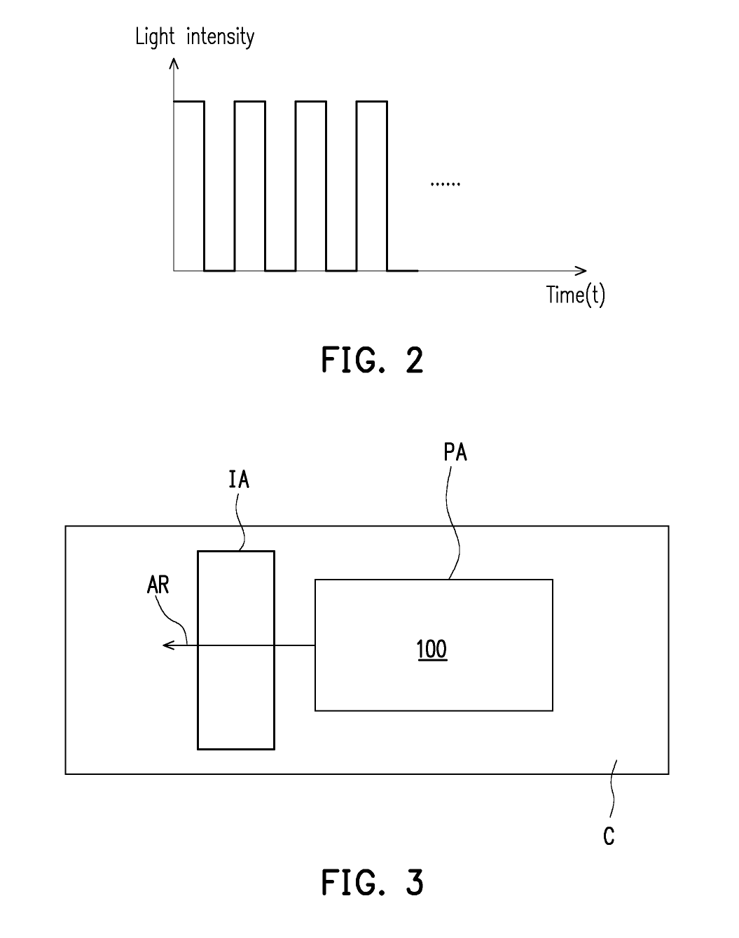

Next, a physical surface heat treatment P is performed on the anti-glare side S100 of the anti-glare cover plate 100 at a temperature greater than or equal to T/2 and less than T to form an anti-glare wear-resistant cover plate 200 shown in FIG. 1B. Here, the physical surface heat treatment can include laser annealing or flash lamp annealing, but is not limited thereto. FIG. 2 shows the relationship between time and light intensity of a physical surface heat treatment. Referring to FIG. 2, the physical surface heat treatment can include performing discontinuous irradiation (pulsed irradiation) on the anti-glare side of the anti-glare cover plate, i.e., the light source is intermittently turned on (or intermittently turned off), such that the light beam emitted by the light source is intermittently irradiated on the anti-glare side of the anti-glare cover plate (i.e., pulsed irradiation is only performed on the anti-glare surface of the anti-glare cover plate), such that the anti-glare surface of the anti-glare cover plate reaches a temperature greater than or equal to T/2 and less than T.

During the physical surface heat treatment, by turning off the light source intermittently and performing pulsed irradiation only on the anti-glare surface of the anti-glare cover plate, heat dissipation of the anti-glare cover plate can be facilitated such that the thermal energy provided by the light source is concentrated on the processed surface. In comparison to placing the anti-glare cover plate in a high-temperature furnace and performing a physical heat treatment on the entire anti-glare cover plate, the intermittent irradiation of the anti-glare side of the anti-glare cover plate with a light source can prevent situations such as warping or deformation of the resulting anti-glare wear-resistant cover plate. As a result, a subsequent process can be facilitated and the difficulty of assembling the anti-glare wear-resistant cover plate with other elements can be lowered.

It should be mentioned that, although the light source in FIG. 2 is turned on for the same amount of time each time, the light source is turned off for the same amount of time each time, and the light intensity of the light source is the same each time, but the invention is not limited thereto. By adjusting the parameters such as the amount of time the light source is turned on each time, the amount of time the light source is turned off each time, the total number of irradiations and the light intensity of each irradiation, the energy provided to the anti-glare surface of the anti-glare cover plate can be controlled, such that the anti-glare surface of the anti-glare cover plate reaches the desired temperature.

The method of performing a physical surface heat treatment on the anti-glare surface of the anti-glare cover plate can be static or dynamic. When the irradiation area provided by the light source is greater than or equal to the area of the region to be processed of the anti-glare surface, a static method can be adopted. That is, a physical surface heat treatment is performed with both the location of the light source and the location of the anti-glare cover plate fixed. Moreover, when the irradiation area provided by the light source is smaller than the area of the region to be processed of the anti-glare surface, a dynamic method is adopted. FIG. 3 is a top view showing a method of performing a physical surface heat treatment at an anti-glare side of an anti-glare cover plate in a dynamic manner. Referring to FIG. 3, when an irradiation area IA provided by the light source is less than an area PA of the region to be processed of the anti-glare surface (FIG. 3 schematically shows the area PA of the region to be processed of the anti-glare surface is equal to the area of the anti-glare surface), the anti-glare cover plate 100 can be moved relative to the light source without changing the location of the light source (or the location of the irradiation area IA). For instance, the anti-glare cover plate 100 for which a physical surface heat treatment is to be performed can be placed on a conveyor belt C such that the conveyor belt C moves the anti-glare cover plate 100 along the direction shown by an arrow AR. However, the method of moving the anti-glare cover plate 100 is not limited thereto. Moreover, in another embodiment, the light source can also be moved relative to the anti-glare cover plate 100 without changing the location of the anti-glare cover plate 100.

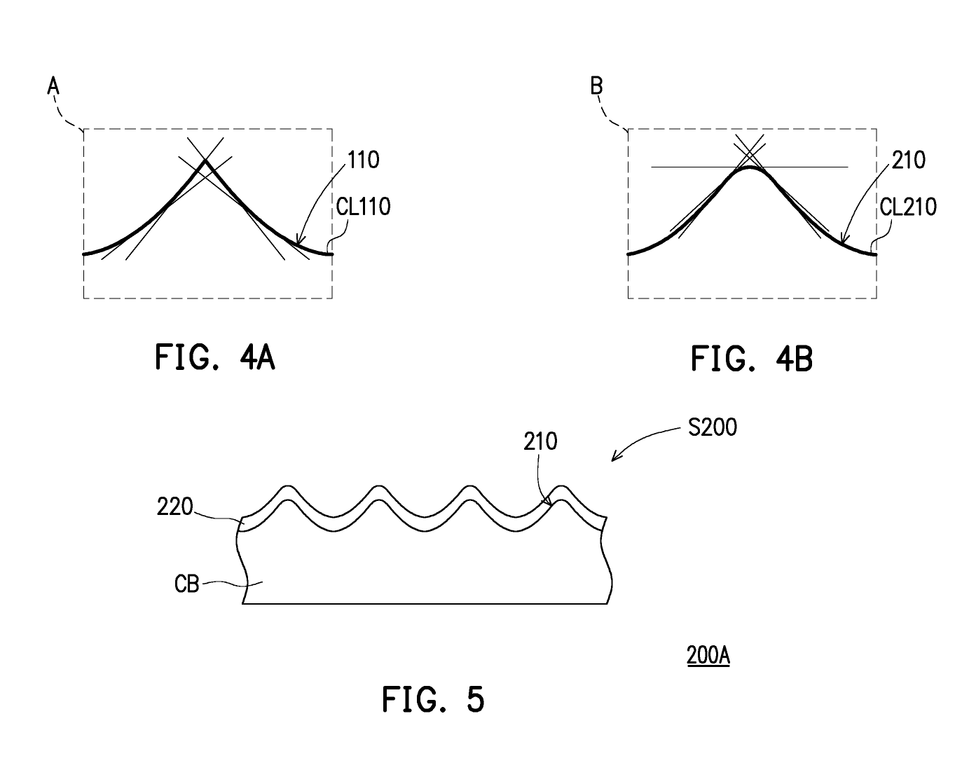

By performing a physical surface heat treatment on the anti-glare side of the anti-glare cover plate, the hardness of the anti-glare cover plate can be increased and the surface topography of the anti-glare cover plate can be changed such that the anti-glare cover plate is more wear resistant. Next, the change in surface topography is described with reference to FIG. 4A and FIG. 4B.

FIG. 4A is an enlarged view of a region A in FIG. 1A. FIG. 4B is an enlarged view of a region B in FIG. 1B. Referring to FIG. 1A, FIG. 1B, FIG. 4A, and FIG. 4B, after the physical surface heat treatment is performed on the anti-glare side S100 of the anti-glare cover plate 100, the anti-glare cover plate 100 forms a cover plate body CB of an anti-glare wear-resistant cover plate 200.

The cover plate body CB has a plurality of microstructures 210 located at an anti-glare side S200 of the cover plate body CB, and the plurality of microstructures 210 of the cover plate body CB correspond to the plurality of microstructures 110 of the anti-glare cover plate 100. Specifically, after the physical surface heat treatment is performed, the plurality of microstructures 110 of the anti-glare cover plate 100 are passivated to form the plurality of microstructures 210 of the cover plate body CB. More specifically, referring to FIG. 1A and FIG. 4A, the plurality of microstructures 110 of the anti-glare cover plate 100 have obvious tips, and a change in slope of a section line CL110 of each of the plurality of microstructures 110 of the anti-glare cover plate 100 on a reference plane (such as a paper surface) perpendicular to the anti-glare cover plate 100 is discontinuous. In FIG. 4A, a plurality of thin solid lines respectively indicate tangent lines of different regions of the section line CL110. As shown in FIG. 4A, the slope is changed from a positive value (refer to the tangent line of the left-hand portion of the section line CL110) to a negative value (refer to the tangent line in the right-hand portion of the section line CL110). In comparison to the plurality of microstructures 110 of the anti-glare cover plate 100, the change in slop of a section line CL210 of each of the plurality of microstructures 210 of the cover plate body CB on a reference plane (such as a paper surface) perpendicular to the cover plate body CB is continuous at least at the top surface of each of the plurality of microstructures 210. In the embodiment, a change in slope of a section line CL210 of each of the plurality of microstructures 210 on the reference plane is continuous. In other words, the change in slope of the section line CL210 of each of the plurality of microstructures 210 on the reference plane is continuous from the bottom surface to the top surface of each of the plurality of microstructures 210. In FIG. 4B, a plurality of thin solid lines respectively indicate tangent lines of different regions of the section line CL210. As shown in FIG. 4B, the slope is decreased from a positive value (refer to the tangent line of the left-hand portion of the section line CL210) to zero (vertex of the section line CL210) and then changed into a negative value (refer to the tangent line of the right-hand portion of the section line CL210). Moreover, it should be mentioned that, in the anti-glare wear-resistant cover plate, the change in slope of the section line should be continuous on the top surface. The change in slop of the section line is not limited to continuous in a region other than the top surface region (such as the bottom surface or a side surface adjacent to the bottom surface).

Via the physical surface heat treatment, in addition to removing impurities (not shown) on the anti-glare cover plate 100, the tips of the anti-glare cover plate 100 can also be passivated to form a gentler rough surface. Therefore, in comparison to the anti-glare cover plate 100, the anti-glare wear-resistant cover plate 200 is less readily damaged during frictional contact, and therefore color shift is not readily generated.

After the physical surface heat treatment, the plurality of microstructures 110 of the anti-glare cover plate 100 are passivated to form the plurality of microstructures 210 of the cover plate body CB. Therefore, a maximum thickness H200 of the cover plate body CB is slightly less than the maximum thickness H100 of the anti-glare cover plate 100. That is, the maximum thickness H200 of the cover plate body CB is also less than 1 mm. More specifically, a depth T210 of each of the plurality of microstructures 210 is slightly less than the depth T110 of each of the plurality of microstructures 110, and a distance D210 between any two adjacent microstructures 210 in the plurality of microstructures 210 (defined as the distance between the highest points of two adjacent microstructures 210) is equal to or close to the distance D110 between any two adjacent microstructures 110 in the plurality of microstructures 110. In the embodiment, the depth T210 of each of the plurality of microstructures 210 is between 0 microns and 5 microns, and the distance D210 between any two adjacent microstructures 210 in the plurality of microstructures 210 is greater than or equal to 1 micron and less than 100 microns.

Based on different needs, the anti-glare wear-resistant cover plate 200 can further include other film layers. FIG. 5 is a partial cross section of an anti-glare wear-resistant cover plate of the invention. Referring to FIG. 5, an anti-glare wear-resistant cover plate 200A is similar to the anti-glare wear-resistant cover plate 200 of FIG. 1B, wherein the same elements are represented by the same reference numerals and are not repeated herein.

The differences between the anti-glare wear-resistant cover plate 200A and the anti-glare wear-resistant cover plate 200 are described below. The anti-glare wear-resistant cover plate 200A further includes an anti-smudge layer 220 disposed on the plurality of microstructures 210. Specifically, after the physical surface heat treatment, the anti-smudge layer 220 is formed on the plurality of microstructures 210 of the cover plate body CB. In another embodiment, an anti-fingerprint layer can replace the anti-smudge layer 220.

The anti-smudge layer 220 (or anti-fingerprint layer) is formed by, for instance, forming a liquid anti-smudge material (or anti-fingerprint material) on the plurality of microstructures 210 via a spray-coating method, and then curing the liquid anti-smudge material (or anti-fingerprint material) to form the anti-smudge layer 220 (or anti-fingerprint layer). Since the physical surface heat treatment can passivate the tips of the anti-glare cover plate to form a gentler rough surface, a liquid anti-smudge material (or anti-fingerprint material) is more readily adhered to the plurality of microstructures 210 such that the resulting anti-smudge layer 220 (or anti-fingerprint layer) has a relatively uniform thickness distribution to prolong the life of the anti-smudge layer 220 (or anti-fingerprint layer).

In an actual wear test, the anti-glare surfaces of four anti-glare cover plates are rubbed back and forth by a 500-g load having a 2 cm-by-2 cm contact area to compare the wear resistance capabilities of an anti-glare cover plate without physical surface heat treatment and three anti-glare cover plates with physical surface heat treatment respectively performed at 400° C., 540° C., and 545° C. The experimental results show that, in comparison to the anti-glare cover plate without physical surface heat treatment, the wear test of all three anti-glare cover plates with physical surface heat treatment is significantly improved. Even when an anti-smudge layer or an anti-fingerprint layer are disposed on the plurality of microstructures of the three anti-glare cover plates with physical surface heat treatment, the wear test is also significantly improved in all cases.

Based on the above, since performing a physical surface heat treatment on the anti-glare side of the anti-glare cover plate facilitates the increase in the hardness of the anti-glare cover plate and can change the surface topography of the anti-glare cover plate such that the anti-glare cover plate is more wear-resistant, the manufacturing method of the anti-glare wear-resistant cover plate of the invention can effectively increase the wear resistance capability of the anti-glare cover plate. Moreover, the anti-glare wear-resistant cover plate made by the manufacturing method above can have good wear resistance capability. Since the physical surface heat treatment can passivate the tips of the anti-glare cover plate to form a gentler rough surface, a liquid anti-smudge material (or anti-fingerprint material) can be more readily adhered to the plurality of passivated microstructures such that the resulting anti-smudge layer (or anti-fingerprint layer) has a relatively uniform thickness distribution to prolong the life of the anti-smudge layer (or anti-fingerprint layer).

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An anti-glare wear-resistant cover plate, comprising:
a cover plate body having a plurality of microstructures located at an anti-glare side of the cover plate body, wherein the plurality of microstructures have a plurality of top surfaces, and a change in slope of a section line of each of the plurality of top surfaces on a reference plane perpendicular to the cover plate body is continuous.

2. The anti-glare wear-resistant cover plate of claim 1, wherein a change in slope of a section line of each of the plurality of microstructures perpendicular to the reference plane is continuous.

3. The anti-glare wear-resistant cover plate of claim 1, wherein a depth of each of the plurality of microstructures is between 0 microns and 5 microns, and a distance between any two adjacent microstructures in the plurality of microstructures is greater than or equal to 1 micron and less than 100 microns.

4. The anti-glare wear-resistant cover plate of claim 1, wherein the cover plate body is a glass cover plate.

5. The anti-glare wear-resistant cover plate of claim 1, further comprising:
an anti-smudge layer or an anti-fingerprint layer disposed on the plurality of microstructures.

6. A manufacturing method of an anti-glare wear-resistant cover plate, comprising:
providing an anti-glare cover plate, wherein a glass transition temperature of the anti-glare cover plate is T; and
performing a physical surface heat treatment on an anti-glare side of the anti-glare cover plate at a temperature greater than or equal to T/2 and less than T.

7. The manufacturing method of the anti-glare wear-resistant cover plate of claim 6, wherein the physical surface heat treatment comprises laser annealing or flash lamp annealing.

8. The manufacturing method of the anti-glare wear-resistant cover plate of claim 6, wherein the anti-glare cover plate has a plurality of microstructures, and after the physical surface heat treatment is performed, the plurality of microstructures are passivated.

9. The manufacturing method of the anti-glare wear-resistant cover plate of claim 8, wherein after the physical surface heat treatment is performed on the anti-glare side of the anti-glare cover plate, the anti-glare cover plate forms a cover plate body, the cover plate body has a plurality of microstructures corresponding to the plurality of microstructures of the anti-glare cover plate, and a change in slope of a section line of each of the plurality of microstructures of the cover plate body on a reference plane perpendicular to the cover plate body is continuous at least on a top surface of each of the plurality of microstructures, the manufacturing method of the anti-glare wear-resistant cover plate further comprising:
forming an anti-smudge layer or an anti-fingerprint layer on the plurality of microstructures of the cover plate body.
